(19) United States
(12) Patent Application Publication
(10) Pub. No.: US 2026/0231286 A1
(43) Pub. Date: Aug. 6, 2026

(54) DRX OPTIMIZATION FOR U2N RELAY POWER SAVING

(71) Applicant: InterDigital Patent Holdings, Inc., Wilmington, DE (US)

(72) Inventors: Taimoor Abbas, Sainte-Julie (CA); Michael Starsinic, Newtown, PA (US); Anuj Sethi, Ottawa (CA); Samir Ferdi, Kirkland (CA); Michelle Perras, Montreal (CA); Saad Ahmad, Montreal (CA); Jung Je Son, Warrington, PA (US)

(73) Assignee: InterDigital Patent Holdings, Inc., Wilmington, DE (US)

(21) Appl. No.: 19/151,729

(22) PCT Filed: Feb. 7, 2024
(86) PCT No.: PCT/US2024/014741

§ 371 Date: Jul. 29, 2025

Related U.S. Application Data
(60) Provisional application No. 63/444,388, filed on Feb. 9, 2023.

(51) Int. Cl. H04W 76/28; H04W 52/02; H04W 68/00

(52) U.S. Cl. CPC H04W 76/28; H04W 52/0216; H04W 68/00

(57) ABSTRACT

A WTRU may determine to align a DRX cycle of the WTRU with respective DRX cycles of one or more remote WTRUs connected to the WTRU. The WTRU may determine a specific identifier to request based on respective POs of the one or more remote WTRUs and/or a PO of the WTRU. The WTRU may send a first message to the network. The first message may include a specific identifier and/or a DRX indication that indicates a request to align the DRX cycle of the WTRU with the respective DRX cycles of the two or more remote WTRUs. The WTRU may receive a second message from the network indicating to use the specific identifier and/or an available DRX cycle. The WTRU may send a third message to the one or more remote WTRUs that indicates the specific identifier, the DRX indication, and/or the available DRX cycle.

### CROSS-REFERENCE TO RELATED APPLICATION

This application claims priority to U.S. Provisional Patent Application No. 63/444,388 filed on Feb. 9, 2023, the entire contents of which are incorporated herein by reference.

### BACKGROUND

Massive Internet of Things (IoT) equipment may consume large amounts of power while only communicating small amounts of data and communicating infrequently. Therefore, Fifth Generation (5G) systems may introduce power saving enhancements to reduce power consumption and to extend battery lifetimes of IoT devices. For example, the IoT device may use extended Discontinuous Reception (DRX) for connection management (CM)-Idle and Radio Resource Control (RRC) inactive status to decrease paging occasions monitored by the IoT device in a period. Also, an IoT device may use a Mobile Initiated Connection Only (MICO) mode to avoid monitoring paging. The MICO mode may work with an Extended Connected Time (which may indicate how long the Radio Access Network (RAN) will keep IoT device in connected mode), active time (which may indicate how long the IoT device will operate in MICO mode after the IoT device enters CM-Idle) and/or a Periodic Registration Timer Control (which may indicate when the IoT device is to perform registration procedure for oncoming downlink (DL) data). The IoT device may negotiate the extended DRX and/or MICO mode with the network during a registration procedure.

### SUMMARY

Systems, methods, and/or apparatuses are described herein that include a wireless transmit/receive unit (WTRU)-to-Network (U2N) Relay WTRU that may send a mobility registration message to an Access and Mobility Management Function (AMF). The mobility registration message may include a Discontinuous Reception (DRX) optimization indication and/or a request for one or more (e.g., a specific) WTRU Identity (WTRU_ID). The procedure to request one or more (e.g., a specific) WTRU_ID may include being calculated by the Relay WTRU based on the comparison of one or more (e.g., all) Remote WTRU's Uu POs with the Relay WTRU's Paging Occasion (PO), which may be used as a reference WTRU_ID to move Remote WTRU's PO. The U2N Relay may send a PC5 message to the Remote WTRU. The PC5 message may include the U2N Relay's WTRU_ID, DRX optimization indication and/or one or more available DRX cycle(s).

Systems, methods and/or apparatuses are described herein with respect to PO alignment. The Relay WTRU may be provisioned with a Relay Service Code (RSC) with DRX optimization indication and/or DRX cycle information. The Relay WTRU may receive a Direct Communication Request (DCR) from a Remote WTRU. The DCR may include the RSC. The Relay WTRU may send a Direct Communication Accept (DCA) to the Remote WTRU. The DCA may include the Relay WTRU's PO alignment assistance information.

Systems, methods and/or apparatuses are described herein with respect to PO re-alignment. PO re-alignment may include the Relay WTRU being connected with PO aligned Remote WTRUs. The Relay WTRU may perform a registration update with the network and/or receive a new WTRU_ID. The Relay WTRU may calculate the new PO (e.g., based on new WTRU_ID). The Relay WTRU may compare the new PO to the old PO.

If the new PO is not aligned with the old PO, the Relay WTRU may send a PC5 request message to inform the connected Remote WTRUs providing new PO alignment assistance information.

A WTRU (e.g., a relay WTRU) may determine to align a DRX cycle of the WTRU with respective DRX cycles of one or more remote WTRUs, for example, that are connected to the WTRU. The WTRU may determine a specific identifier to request, for example, based on respective paging occasions (POs) of the one or more remote WTRUs and/or a PO of the WTRU. The WTRU may send a first message to the network. The first message may include a specific identifier and/or a DRX indication (e.g., a DRX optimization indication) that indicates a request to align the DRX cycle of the WTRU with the respective DRX cycles of the two or more remote WTRUs. The WTRU may receive a second message from the network indicating to use the specific identifier and/or an available DRX cycle. The available DRX cycle may be assigned to the WTRU and/or the two or more remote WTRUs, for example, based on the DRX indication. The WTRU may receive the second message from an access and mobility management function (AMF). The WTRU may send a third message to the two or more remote WTRUs. The third message may indicate the specific identifier, the DRX indication, and/or the available DRX cycle.

The WTRU may calculate the specific identifier. For example, the WTRU may calculate the specific identifier based on a comparison of one or more POs of the two or more remote WTRUs with the PO of the WTRU. The WTRU may determine to align the DRX cycle of the WTRU based on the comparison of the one or more POs of the two or more remote WTRUs with the PO of the WTRU.

The WTRU may receive respective PO aligned indications from each of the two or more remote WTRUs. The WTRU may receive a disconnect request message from a remote WTRU of the two or more remote WTRUs based on the PO alignment between the remote WTRU and the WTRU being unsuccessful. The WTRU may monitor POs and data delivery of the two or more remote WTRUs based on the available DRX cycle.

The determination to align a DRX cycle of the WTRU with the respective DRX cycles of the two or more remote WTRUs connected to the WTRU may be based on reception of a direct communication request message from one of the two or more remote WTRUs.

The specific identifier may be a first specific identifier. The WTRU may perform a registration update with the network. The WTRU may receive a second specific identifier in response to the registration update. The WTRU may calculate an updated PO based on the second specific identifier. The WTRU may send a fourth message to the two or more remote WTRUs, for example, when the updated PO is not aligned with the initial PO. The fourth message may indicate the second specific identifier.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example of a reference model of 5G/NextGen Network.

FIG. 3 is a system diagram illustrating an architecture model using a Layer-2 WTRU-to-Network Relay WTRU.

FIG. 4 is a system diagram illustrating an example of end-to-end control plane for a Remote WTRU using Layer-2 WTRU-to-Network Relay WTRU.

FIG. 5 is a diagram illustrating an example of Paging Frame and Paging Occasion.

FIG. 6 is a flow chart diagram illustrating an example of a Relay WTRU that asks the Remote WTRU to move its PO to align with the Relay WTRU's PO.

FIG. 7 is a flow chart diagram illustrating an example of a Remote WTRU that seeks network PO alignment based on Relay WTRU POs.

FIG. 8 is a flow chart diagram illustrating an example of a Remote WTRU that seeks network PO re-alignment.

### DETAILED DESCRIPTION

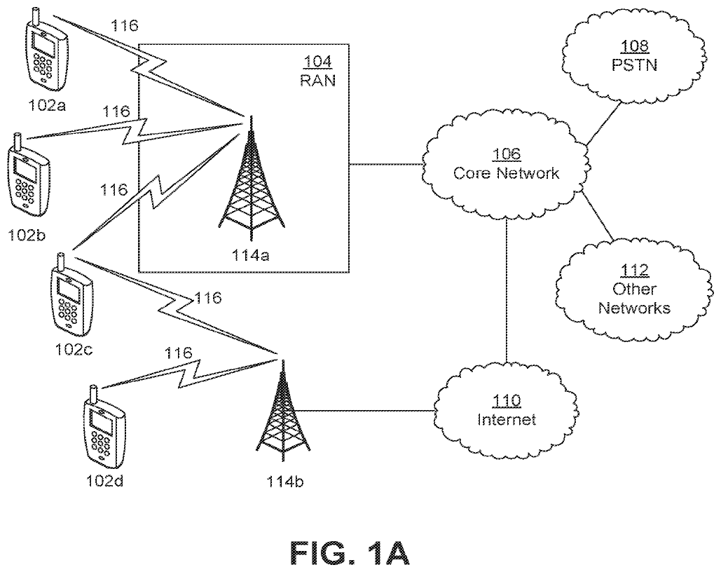

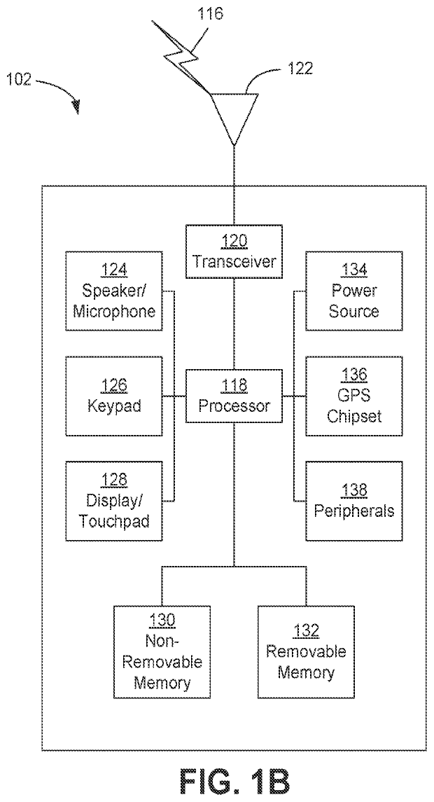

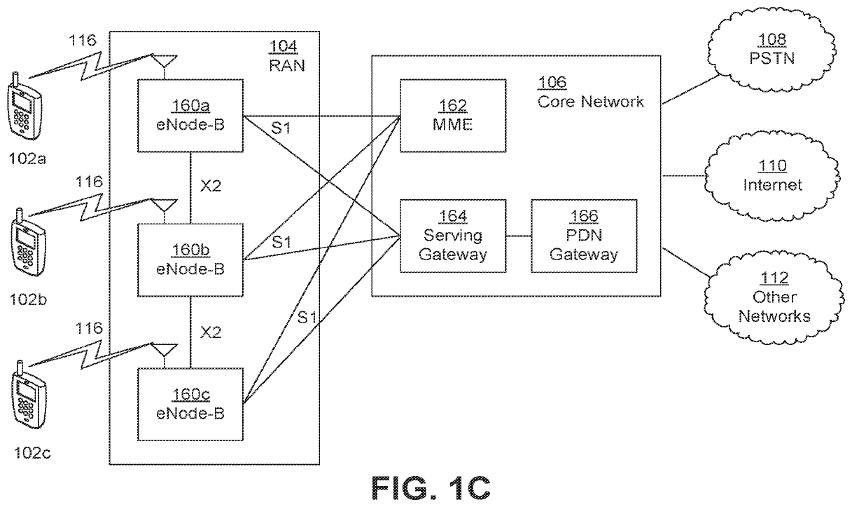

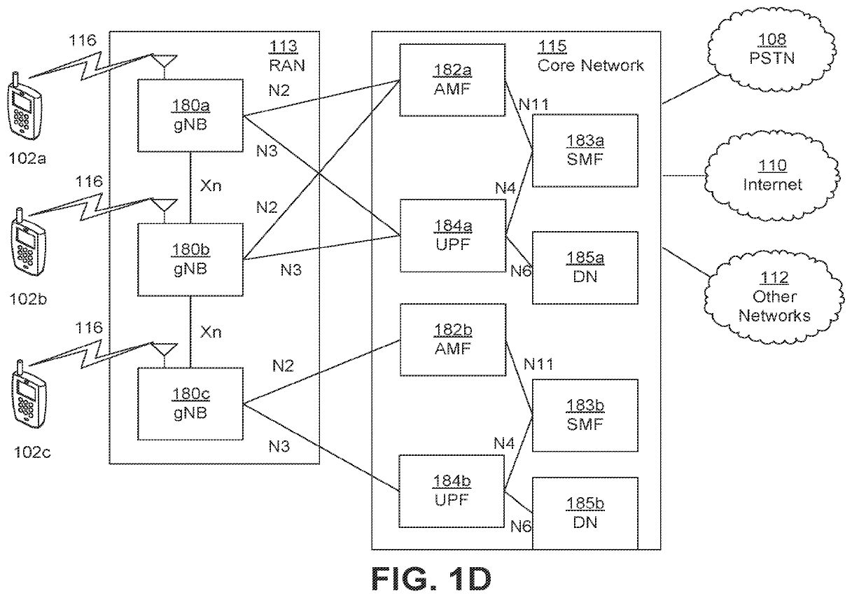

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

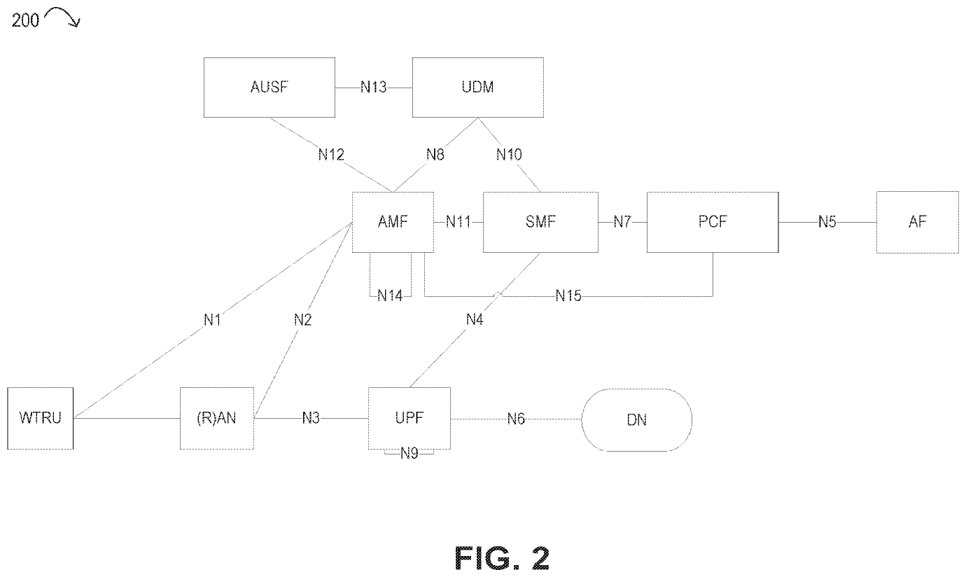

FIG. 2 depicts an example reference model of a network architecture (e.g., for 5G and/or NextGen network). RAN as described herein may refer to a radio access network (e.g., based on the 5G RAT and/or Evolved E-UTRA that connects to the NextGen core network). An Access Control and Mobility Management Function (AMF) may include one or more of the following functionalities: Registration management, Connection management, Reachability management, Mobility management, etc. A Session Management Function (SMF) may include one or more of the following functionalities: session management (e.g., including session establishment, modify, and/or release); WTRU Internet Protocol (IP) address allocation; selection and/or control of User Plane function; etc. A User Plane Function (UPF) may include one or more of the following functionalities: packet routing and forwarding, packet inspection, traffic usage reporting, etc.

A Pro-Se WTRU-to-Network Relay entity may provide the functionality to support connectivity to the network for one or more remote WTRUs. If a Remote WTRU is out of NR coverage and/or cannot communicate with the network directly (e.g., or in NR coverage but prefers to use relayed PC5 interface for communication), the Remote WTRU may discover and/or select a ProSe WTRU-to-Network Relay. The Remote WTRU may establish a PC5 session with the ProSe WTRU-to-Network Relay. The Remote WTRU may access the network via the ProSe WTRU-to-Network Relay.

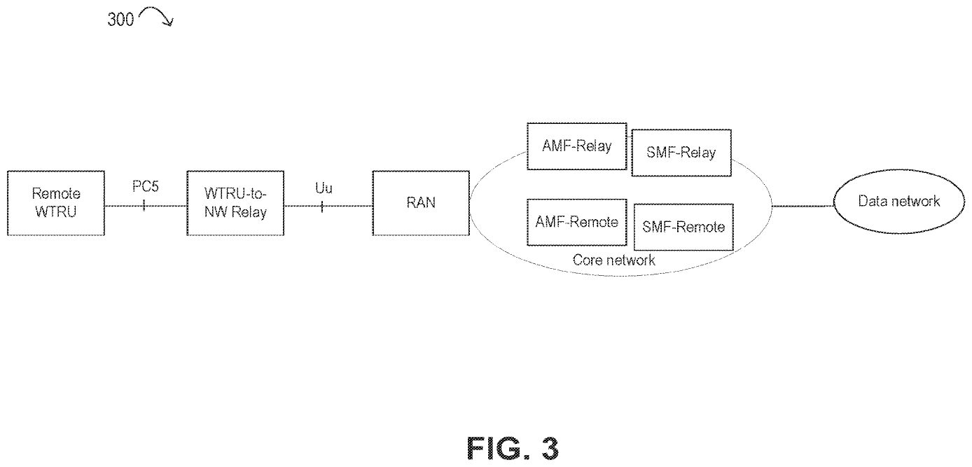

FIG. 3 depicts an example architecture model using a Layer-2 WTRU-to-Network Relay. The Layer-2 WTRU-to-Network Relay may provide the functionality to support connectivity to the network for Layer-2 Remote WTRUs via AS layer forwarding.

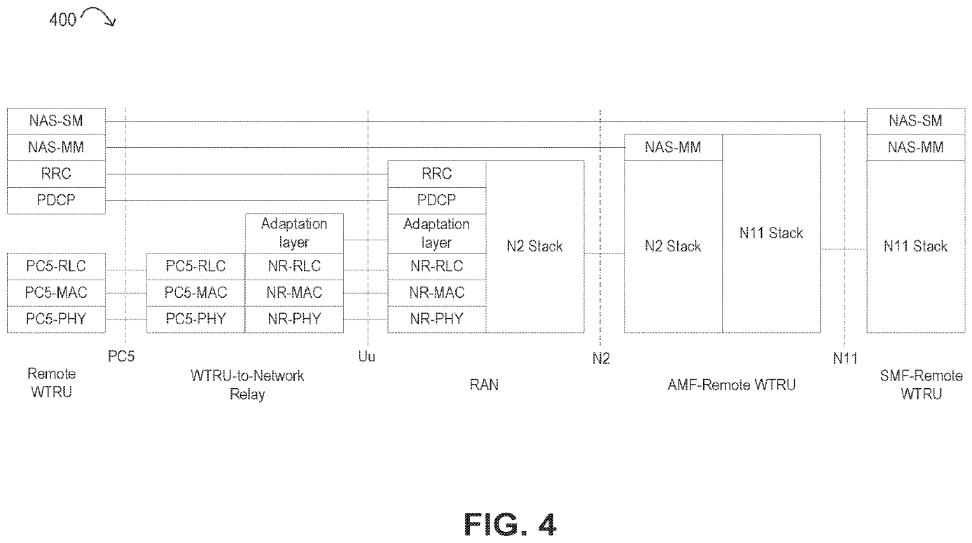

FIG. 4 depicts an example end-to-end control plane for a Remote WTRU using a Layer-2 WTRU-to-Network Relay. FIG. 4 depicts a control plane protocol stack.

After a PC5 session is established between the Layer-2 Remote WTRU and the Layer-2 WTRU-to-Network Relay, for example, the Layer-2 WTRU-to-Network Relay may forward RRC signaling and/or traffic between the Layer-2 Remote WTRU and the RAN. When receiving a signaling from Uu interface, for example, the RAN may determine whether the signaling received is from the WTRU-to-Network relay itself or from the Remote WTRU via the WTRU-to-Network Relay. The RAN may perform corresponding procedures with the AMF-Relay (e.g., the AMF which serves the WTRU-to-Network Relay) and/or the AMF-Remote WTRU (e.g., the AMF which serves the Remote WTRU). The AMF-Relay and/or the AMF-Remote WTRU may belong to different core network(s). To provide AS layer forwarding, for example, the Layer-2 WTRU-to-Network Relay may keep in connected mode if any Layer-2 Remote WTRU is in connected mode.

Systems, methods, and apparatuses described herein may include power saving enhancements with respect to the Internet of Things (IoT). For example, one or more IoT power saving enhancements may be provided. A significant amount of IoT equipment may consume large amounts of power while (e.g., only) communicating with small amount of data and/or infrequently. One or more power saving enhancement(s) may reduce power consumption and/or extend battery lifetime of IoT device(s). For example, an IoT device may have an extended Discontinuous Reception (DRX) for connection management (CM)-Idle and/or RRC inactive status, for example, to decrease Paging occasion monitored by the IoT device in a period. Additionally or alternatively, an IoT device may use Mobile Initiated Connection Only (MICO) mode to avoid monitoring paging. The MICO mode may work with Extended Connected Time (e.g., indicate how long the RAN may keep the IoT device in connected mode), Active time (e.g., indicate how long the IoT device may enter MICO mode after the IoT device enters CM-Idle), and/or Periodic Registration Timer Control (e.g., indicate when the IoT device may perform registration procedure for oncoming DL data). The IoT device may negotiate extended DRX and/or MICO mode with the network during the registration procedure.

Systems, methods, and apparatuses are described herein with respect to DRX for paging. DRX in idle mode may be used for reducing WTRU's power consumption. A Paging Frame (PF) may comprise one Radio Frame. A PF may comprise one or more (e.g., multiple) Paging Occasion(s) (POs). When DRX is used, the WTRU may monitor (e.g., only monitor) one PO per DRX cycle.

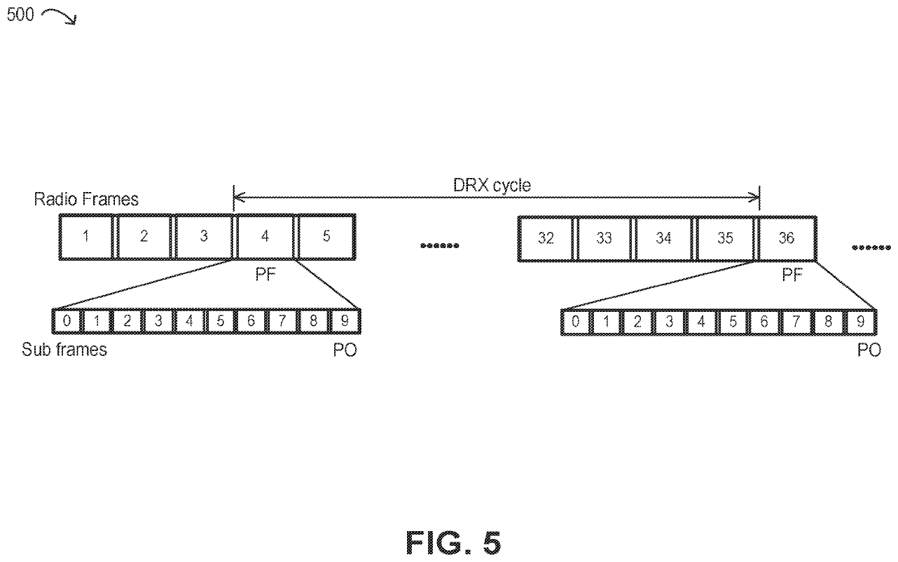

FIG. 5 illustrates an example Paging Frame and an example Paging Occasion. The WTRU and/or the RAN may determine a Paging Frame and/or a Paging Occasion based on the WTRU ID (e.g., 5G-serving-temporary mobile subscriber identity (5G-S-TMSI) and/or DRX cycle of the WTRU). For example, the paging frame and/or paging occasion may be calculated using Equations 1 and 2 respectively

$$SNF mod T = ( T div N ) ⋆ ( WTRU\_ID mod N ) \qquad ( 1 )$$

$$I\_ s = floor ( WTRU\_ID / N ) mod Ns \qquad ( 2 )$$

T may represent the DRX cycle of the WTRU. N may be represented as N=Min (T, nB). nB may represent the total number of POs in one DRX cycle. For example, nB may be T/32, T/16, T/8, T/4, T/2, T, 2T, or 4T. The value of nB may be indicated in system information. Ns may represent the number of POs in a PF. I_s may represent the sub=frame number (e.g., PO) in the PF. When the AMF sends the one or more paging message(s) to the RAN, the AMF may include the WTRU ID and/or the DRX cycle in the paging message. The RAN may perform paging at the corresponding PO.

When the WTRU-to-Network Relay is an IoT device, one or more WTRU-to-Network Relay power consumption requirement(s) may be considered. When both L2 WTRU-to-Network (U2N) Relay WTRU and/or L2 U2N Remote WTRU are in RRC IDLE or RRC INACTIVE, the L2 U2N Relay may monitor one or more paging occasions of its connected L2 U2N Remote WTRU(s). When a L2 U2N Relay WTRU monitors paging for a L2 U2N Remote WTRU, the L2 U2N Relay WTRU may monitor one or more (e.g., all) POs of the L2 U2N Remote WTRU. The Relay WTRU monitoring one or more (e.g., multiple) paging occasions (e.g., all POs of the L2 U2N Remote WTRUs) may be inefficient in terms of power consumption.

When the U2N Relay is an IoT device, one or more power saving consumption requirements may be considered. When a WTRU is in RRC_IDLE mode, a WTRU implementation may power down the WTRU in parts, at least between the POs. When the WTRU is monitoring multiple POs and/or the POs are not sufficiently separated in time, for example, the WTRU may have fewer (e.g., or no) opportunities to power down one or more parts of the WTRU and/or save power. One problem addressed, as provided herein, may be how to enable a WTRU-to-Network Relay's power saving by optimizing jointly DRX for both U2N Relay and/or Remote WTRUs, especially if there are one or more Remote WTRUs accessing the network via U2N Relay.

A Remote WTRU may access the network via the U2N Relay WTRU. A (e.g., single) U2N Relay WTRU may assist one or more (e.g., multiple) Remote WTRUs to communicate to the network via the Relay WTRU. The Remote WTRU may belong to the same network (e.g., public land mobile network (PLMN)) as the Relay WTRU. The Remote WTRU may have the same AMF as the Relay WTRU. The Remote WTRU may have the same RAN as the Relay WTRU. The Remote WTRU and/or the Relay WTRU may be configured to be extended DRX (eDRX) and/or MICO capable, which may be shared in the initial registration and/or discovery messages. The Remote WTRU and/or the Relay WTRU may successfully be performing DRX that serves the Remote WTRU and/or the Relay WTRU best in terms of WTRU power saving. For example, the DRX may be selected to optimize WTRU power saving. Aligning the DRX cycles and/or POs may optimize (e.g., further optimize) power saving on the U2N Relay WTRU and the one or more Remote WTRUs. Power saving of the U2N Relay WTRU may be further optimized by synchronizing and/or aligning the DRX and/or POs of the Remote WTRUs and/or Relay WTRU, for example, while respecting the one or more power saving requirement(s) of the Remote WTRUs.

The terms Relay WTRU, WTRU-to-Network Relay WTRU, WTRU-to-NW Relay WTRU, U2N Relay, and U2N Relay WTRU may be used interchangeably herein. The term Relay AMF may be used interchangeably with the term AMF herein.

A Relay WTRU may determine to move one or more POs of a Remote WTRU. The Remote WTRU may receive an optimization indication (e.g., a DRX optimization indication). The DRX optimization indication may indicate that the Relay WTRU requests to synchronize the DRX cycles and/or to align the Uu PO of the Remote WTRU with the Uu PO of the Relay WTRU that may enable power saving for the U2N Relay WTRU. The Remote WTRU may receive a DRX optimization indication from the U2N Relay WTRU (e.g., in a PC5 message). The Remote WTRU may send (e.g., in a PC5 message) the (e.g., specific) identifier (e.g., WTRU_ID) of the Remote WTRU (e.g., WTRU_ID that is used to calculate the Uu PO of the Remote WTRU) and/or its Remote DRX cycle to the U2N Relay WTRU. The term WTRU_ID may be used interchangeably herein with the term specific identifier.

The U2N Relay WTRU may send a mobility registration message to the AMF. The mobility registration message may include a DRX indication (e.g., optimization indication, synchronization indication, or alignment indication). For example, the mobility registration message may include a DRX optimization indication and/or a request for a specific identifier (e.g., WTRU_ID) The DRX optimization indication may indicate a request to synchronize and/or align the DRX of one or more WTRUs. The Relay WTRU may calculate the specific identifier (e.g., the specific WTRU_ID) to request based on a comparison of one or more (e.g., all) the Remote WTRU's Uu POs with the Uu PO of the Relay WTRU, as described herein For example, the Remote WTRU may determine the specific identifier (e.g., WTRU_ID) to request based on respective POs of the one or more remote WTRUs and a PO of the Relay WTRU. The specific WTRU_ID may be used as a reference WTRU_ID, for example, to move the PO of the Remote WTRU(s), as described herein. The U2N Relay WTRU may send a PC5 message to the Remote WTRU(s). The PC5 message may include the specific identifier (e.g., such as the U2N Relay WTRU's WTRU_ID), the DRX optimization indication, and/or an available DRX cycle.

The Remote WTRU(s) may receive the WTRU_ID of the Relay WTRU in a PC5 message from the Relay WTRU. Upon reception of the PC5 message, for example, the Remote WTRU(s) may align its Uu PO (e.g., by requesting the same WTRU_ID as the Relay WTRU's from the AMF in a mobility registration message). The Remote WTRU(s) may receive the WTRU_ID from the AMF. The received WTRU_ID may be the same or similar to the WTRU_ID of the Relay WTRU or such as to be associated with a PO aligned with PO of the Relay WTRU. Based on these WTRU_IDs (e.g., for Remote WTRU(s) and Relay WTRU), each of the Remote WTRUs may calculate and/or compare the respective PO of the Remote WTRU with the PO of the Relay WTRU, as described herein. The Remote WTRU(s) may send a PC5 message to the U2N Relay WTRU. The PC5 message may include a PO aligned indication, as described herein.

Systems, methods, and apparatuses are described herein with respect to a Remote WTRU that may seek network PO alignment based on Relay WTRU POs.

A Remote WTRU may perform a PO alignment. A Remote PO may be provisioned with a Relay Service Code (RSC), with a DRX optimization indication, and/or DRX cycle information. The Remote WTRU may discover and/or select the Relay WTRU providing service with the RSC. The Remote WTRU may send a Direct Communication Request (DCR) to the Relay WTRU. The DCR may include the RSC. The Remote WTRU may receive a DCA. The DCA may include the PO alignment assistance information of the Relay WTRU (e.g., Relay WTRU_ID as a reference WTRU_ID, DRX parameters). The Remote WTRU may compute the PO of the Relay WTRU based on a provided reference WTRU_ID and/or may compare PO of Relay WTRU with a computed PO of the Remote WTRU. The Remote WTRU may send a registration update request to the AMF. The registration update request may include PO alignment assistance information. The Remote WTRU may receive a registration update response. The registration update response may include a new WTRU_ID. The Remote WTRU may compute a PO from the new WTRU_ID and/or verify that the computed PO is aligned with the PO of the Relay WTRU. The Remote WTRU may determine whether the PO alignment with the Relay WTRU is successful. The Remote WTRU may use the connection with the Relay WTRU, for example, if the PO alignment is successful. The Remote WTRU may send a disconnect (e.g., link release) request to the Relay WTRU. For example, the Relay WTRU may be configured to receive the disconnect (e.g., link release) request message from the Remote WTRU(s) that determined that the PO alignment between the Remote WTRU(s) and the Relay WTRU was unsuccessful. The disconnect request may indicate the PO misalignment reason otherwise (e.g., to select another relay).

A Remote WTRU may perform and/or participate in a PO re-alignment. The remote WTRU may be connected with a PO aligned Relay WTRU. The Remote WTRU may receive (e.g., periodically) a PC5 request message (e.g., maintenance message such as LMR, keep alive) indicating a new WTRU_ID for the Relay WTRU. The Remote WTRU may send a PC5 response message to the Relay WTRU confirming successful PO alignment.

A Relay WTRU may perform and/or participate in a PO alignment. The U2N Relay WTRU may be provisioned with an RSC with DRX optimization indication and/or DRX cycle information. The U2N Relay WTRU may receive a DCR from a Remote WTRU. The DCR may include the RSC. The U2N Relay WTRU may send a DCA to the Remote WTRU. The DCA may include the U2N Relay's PO alignment assistance information.

A Relay WTRU may perform and/or participate in a PO re-alignment. The U2N Relay WTRU may be connected with PO aligned Remote WTRUs. For example, the specific identifier may be a first specific identifier and/or the U2N Relay WTRU may perform a registration update with the network. The U2N Relay WTRU may receive a second specific identifier (e.g., new WTRU_ID). The U2N Relay WTRU may receive the second specific identifier, for example, based on performing a registration update with the network. The U2N Relay WTRU may calculate an updated (e.g., new) PO based on the second specific identifier (e.g., new WTRU_ID). The U2N Relay WTRU may compare the new PO to the old PO. If the new PO is not aligned with the old PO, for example, the U2N Relay WTRU may send a PC5 request message to inform the connected Remote WTRUs providing new PO alignment assistance information. For example, the Relay WTRU may send a message to the one or more WTRUs when the PO is not aligned with an initial PO. The message may indicate the specific identifier.

With respect to the Remote WTRU and/or a Relay AMF there may be explicit PO alignment. The AMF may receive a first registration request message from a WTRU and/or Relay (e.g., such as a Relay AMF and/or a Relay WTRU). The first registration request message may include PO alignment assistance information. The AMF may assign a new WTRU_ID. For example, the new WTRU_ID may be used to align the corresponding PO based on PO alignment assistance information. The AMF may store an indication in the Remote WTRU context. The Relay WTRU_ID allocation may be subject to one or more PO alignment constraints. The AMF may send a registration response. The registration response may include the new WTRU_ID. The new WTRU_ID may fulfill the PO alignment requirement. For example, the AMF may send the second message (e.g., as described herein, at 620, etc.) to the Relay WTRU.

With respect to the Remote WTRU and/or Relay AMF, there may be implicit PO alignment and/or maintenance of PO alignment. The AMF may receive a registration request message from a WTRU. The Relay AMF may be without PO alignment assistance information (e.g., Remote WTRU/Relay AMF may be already PO aligned). If the Remote WTRU/Relay WTRU context in the AMF has an indication that the Remote WTRU/Relay WTRU is subject to one or more PO constraints and/or a new WTRU_ID is to be generated, the AMF may assign a new WTRU_ID. The new WTRU_ID may align the corresponding PO to the PO associated with the old WTRU_ID. The AMF may send a registration response with a new WTRU_ID that fulfils the PO alignment requirement.

If the AMF cannot allocate the WTRU_ID, for example, to the WTRU/Relay fulfilling the PO alignment requirement (e.g., due to PO collision, WTRU_ID reuse/collision), the WTRU/Relay may perform a PO re-alignment based on the new WTRU_ID, as described herein.

Systems, methods, and apparatuses may be provided herein with respect to Power saving for WTRU-to-Network Relay WTRU. There may be one or more (e.g., multiple) Remote WTRUs connected to a U2N Relay to access the network via the U2N Relay. One or more examples/embodiments may be applicable when both the U2N Relay WTRU and one or more (e.g., all) Remote WTRUs belong to the same network. One or more examples/embodiments may be applicable when the U2N Relay WTRU and/or one or more (e.g., all) Remote WTRUs belong to the same network and/or the same RAN, but one or more different AMF(s). One or more examples/embodiments may be applicable when the U2N Relay WTRU and/or one or more (e.g., all) Remote WTRUs belong to one or more different network(s) and/or one or more different AMF(s), but the same RAN.

Systems, methods, and apparatuses may be provided herein with respect to a Relay WTRU that may determine to move Remote WTRU's POs. In examples, the U2N Relay WTRU may determine to move one or more Remote WTRU's PO such that it is sufficiently aligned with the PO of the Relay WTRU. There may be one or more Remote WTRUs connected to a U2N Relay WTRU. The Relay WTRU may try to align POs for one or more (e.g., all) the Remote WTRUs. In examples, the Relay WTRU in a mobility registration message may request a specific WTRU_ID for itself. The WTRU_ID may be determined based on the calculation and/or comparison of one or more POs of the one or more Remote WTRUs with the PO of the Relay WTRU. Additionally or alternatively, the Relay WTRU may include a DRX optimization indication in the registration update message. The DRX optimization indication (e.g., DRX synchronization indication, DRX alignment indication) may indicate a desire of the Relay WTRU to synchronize the DRX cycles and/or to align the one or more Uu POs of the Remote WTRUs with the Uu PO of the Relay WTRU. Aligning the Uu PO of the Relay WTRU with one or more Uu PO(s) of the Remote WTRUs may enable power saving for the U2N Relay WTRU. The AMF may assign the WTRU_ID and/or a DRX cycle (e.g., an available DRX cycle) to the Relay WTRU. For example, the available DRX cycle may be assigned to the Relay WTRU and/or the one or more remote WTRUs based on the DRX optimization indication. The Relay WTRU may send the WTRU_ID of the Relay WTRU, the available DRX cycle, and/or the DRX optimization indication to the Remote WTRUs. Each of the Remote WTRUs may attempt to move its PO, for example, by requesting the same WTRU_ID as the Relay WTRU's WTRU_ID from the AMF, for PO calculation.

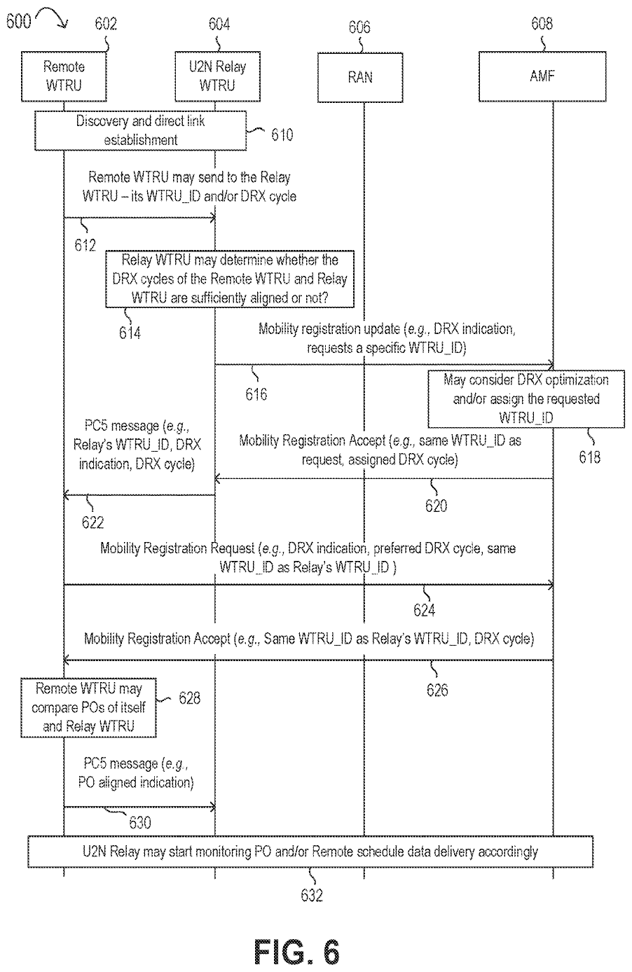

FIG. 6 is a flow chart diagram depicting an example PO alignment 600. In the example PO alignment 600, a Relay WTRU 604 may request one or more Remote WTRUs (e.g., such as remote WTRU 602) to move its PO to align with the Relay WTRU's PO.

At 610, The U2N Relay WTRU 604 and/or the Remote WTRU 602 may perform discovery and/or connection establishment. Discovery and/or connection establishment may include an initial broadcast message (e.g., from the U2N Relay WTRU 604 to the Remote WTRU 602) that may include one or more parameters (e.g., relay capability, eDRX/MICO support, relay service code, etc.). Additionally or alternatively, there may be an DRX optimization indication. The DRX optimization indication may indicate the desire of the Relay WTRU 604 to synchronize the one or more DRX cycles (e.g., of the Remote WTRU 602 and the Relay WTRU 604) and/or to align the one or more Uu PO(s) of the one or more Remote WTRU's Uu PO with the Uu PO of the Relay WTRU 604. For example, a Relay WTRU 604 may determine to align a DRX cycle of the Relay WTRU 604 with respective DRX cycles of one or more Remote WTRUs (e.g., such as the Remote WTRU 602) connected to the Relay WTRU 604. Aligning the one or more Uu PO(s) of the one or more Remote WTRU(s) 602 with the Uu PO of the Relay WTRU 604 may enable power saving for the U2N Relay WTRU 604. Additionally or alternatively, the DRX optimization indication may be sent in a link modification message, for example, if the PC5 connection is already established between the Remote WTRU 602 and the U2N Relay WTRU 604. There may be one or more Remote WTRUs (e.g., such as the remote WTRU 602) that are connected to the U2N Relay WTRU 604 while the U2N Relay WTRU 604 and/or Remote WTRU 602 perform discovery and/or connection establishment.

At 610, one or more (e.g., each) Remote WTRUs (e.g., such as the Remote WTRU 602) may receive the DRX optimization indication from the U2N Relay WTRU 604 in a PC5 message (e.g., in a discovery message, link modification message, and/or direct communication accept message). At 612, One or more (e.g., each) Remote WTRUs (e.g., such as the remote WTRU 602) may send its Remote WTRU_ID (e.g., the WTRU_ID that is used to calculate the Uu PO of the Remote WTRU(s)) and/or a DRX cycle to the U2N Relay WTRU 604. For example, the determination to align a DRX cycle of the relay WTRU 604 with the respective DRX cycles of the one or more remote WTRUs 602 connected to the relay WTRU 604 may be based on reception of the direct communication message, which includes the DRX optimization indication, from one of the one or more Remote WTRUs 602. For example, the Relay WTRU 604 may determine whether to align the DRX cycle of the Relay WTRU 604 with the respective DRX cycles of one or more Remote WTRUs (e.g., such as the Remote WTRU 602) based on whether the direct communication message includes the DRX optimization indication. The direct communication message may be a PC5 message. For example, the direct communication message may a direct link establishment message, a direct link modification message, a link identifier update message, and/or the like.

At 614, the Relay WTRU 604 may use one or more (e.g., each) WTRU_ID of the Remote WTRU(s) 602, as received from one or more (e.g., all) of the Remote WTRUs 602 to calculate the Uu PO of one or more (e.g., all) of the Remote WTRUs 602. Additionally or alternatively, the Relay WTRU 604 may calculate, at 614, its own Uu PO using the WTRU_ID of the Relay WTRU 604. The Relay WTRU 604 may compare, at 614, the POs and/or DRX cycles, of the one or more Remote WTRUs 602 with its own, to determine if the DRX cycles are synchronized and/or if the POs are sufficiently aligned (e.g., if the Relay WTRU 604 has the possibility to enable power saving by deploying one or more power down period(s) between the POs). For example, POs may be considered sufficiently aligned when the Relay WTRU can have longer down periods (e.g., idle periods) than without the DRX optimization. For example, the Relay WTRU 604 may determine whether to initiate alignment of the DRX cycle of the Relay WTRU 604 with the DRX cycle(s) of the remote WTRUs (e.g., such as Remote WTRU 602) connected to the Relay WTRU 604. The determination to align the DRX cycle of the Relay WTRU 604 may be based on the comparison of the one or more POs of the one or more Remote WTRUs 602 with the PO of the Relay WTRU 604. If the Relay WTRU 604 determines that the POs are not sufficiently separated in time, the Relay WTRU 604 may initiate POs alignment procedure. For example, POs may be considered sufficiently separated when the POs are distributed over a time window. The POs for the remote WTRUs 602 may be close enough in time that the relay WTRU 604 can go to sleep when there is no paging, for example, to optimize power saving of the relay WTRU 604. The PO alignment procedure may include a Relay WTRU 604 request to move one or more Remote WTRU's PO such that the one or more Remote WTRU's PO(s) are aligned with the Relay WTRU's PO, as provided herein.

At 616, the Relay WTRU 604 may send a first (e.g., non-access stratum (NAS)) message to the network. For example, the Relay U2N Relay WTRU 604 may send a first (e.g., NAS) message (e.g., a mobility registration message) to the AMF 608. The first message may include a DRX indication (e.g., a DRX optimization indication, a DRX synchronization indication, a DRX alignment indication, etc.) associated with the Relay WTRU 604 and the one or more remote WTRUs (e.g., such as the remote WTRU 602). For example, the first message may include the DRX optimization indication and/or a specific identifier (e.g., a request for a specific WTRU_ID). The DRX optimization indication may indicate a request to align the DRX cycle of the Relay WTRU 604 with the respective DRX cycles of the one or more remote WTRUs (e.g., such as the remote WTRU 602). The Relay WTRU 604 may calculate the specific identifier (e.g., the specific WTRU_ID). The calculation of the specific identifier may be based on the comparison of one or more (e.g., all) of the Uu POs of the Remote WTRU(s) with the PO of the Relay WTRU 604, as provided herein. The specific identifier (e.g., specific WTRU_ID) may be used as a reference WTRU_ID to move one or more PO(s) of the one or more Remote WTRU(s) 602. Additionally or alternatively, the Relay WTRU 604 may send its current WTRU_ID to the one or more Remote WTRU(s) 602 for PO alignment, as provided herein.

At 618, the AMF 608 may consider the power saving of the Relay WTRU 604 (e.g., DRX optimization indication) and/or assign the requested (e.g., or similar) specific identifier (e.g., specific WTRU_ID) to the Relay WTRU 604, as provided herein.

At 620, the relay WTRU 604 may receive a second (e.g., NAS) message (e.g., a mobility registration accept message) from the network (e.g., the AMF 608). For example, the AMF 608 may send the second (e.g., NAS) message to the U2N Relay WTRU 604. The second message may include a new WTRU_ID. The new WTRU_ID may be the same as requested. The mobility registration accept message may include information associated with assigning a DRX cycle to the Relay WTRU 604. For example, the second message may indicate an assigned DRX cycle (e.g., an available DRX cycle) associated with the Relay WTRU 604 and/or the one or more Remote WTRUs (e.g., such as the remote WTRU 602).

At 622, the U2N Relay WTRU 604 may send a third message (e.g., a PC5 message) to the one or more Remote WTRUs (e.g., such as the Remote WTRU 602). The third message may be a link modification request. The third message may be a new PC5 message. The third message may indicate the specific identifier (e.g., the specific WTRU_ID), the DRX indication, and/or one or more available DRX cycle(s) associated with the U2N Relay WTRU 604.

At 624, the Remote WTRU 602 may attempt to align its Uu PO, for example, upon reception of the PC5 message from the Relay WTRU 604. The Remote WTRU 602 may attempt to align its Uu PO by requesting the same WTRU_ID as the Relay WTRU's 604 from the AMF 608 in a mobility registration request/update message. For example, the Remote WTRU 602 may send, at 624, the mobility registration update request/update message to the AMF 608. The mobility registration request/update message may indicate the DRX indication, a preferred DRX cycle, and/or the specific identifier. For example, the remote WTRU 602 may request the same identifier as the Relay WTRU 604 via the mobility registration request/update message. The preferred DRX cycle may be one of the one or more available DRX cycles indicated by the Relay WTRU 604. For example, the remote WTRU 602 may select the preferred DRX cycle from the one or more available DRX cycles (e.g., received from the Relay WTRU 604).

At 626, the Remote WTRU 602 may receive a mobility registration accept message from the AMF 608. The mobility registration accept message may include the WTRU_ID that is the same or similar to the WTRU_ID of the Relay WTRU 604. For example, the network (e.g., the AMF 608) may confirm the requested DRX optimization. The network (e.g., the AMF 608) may provide the corresponding ID (e.g., WTRU_ID) and/or one or more available DRX cycle(s) as additional information to the remote WTRU 602. The mobility registration accept message may include the preferred DRX cycle. The Remote WTRU 602 may apply a PO associated with the preferred DRX cycle.

At 628, the Remote WTRU 602 may compare its PO with the PO of the Relay WTRU 604, for example, based on the one or more WTRU_IDs (e.g., Relay WTRU ID and/or Remote WTRU ID). For example, the Remote WTRU 602 may determine whether the PO of the remote WTRU 602 is aligned with the PO of the Relay WTRU 604.

At 630, the Remote WTRU 602 may send a PC5 message to the U2N Relay WTRU 604. The PC5 message may include the PO aligned indication, for example, if the POs are aligned. If the POs are not aligned, for example, a PO not aligned indication may be included and/or the Relay WTRU and/or Remote WTRU may determine to release the PC5 connection. For example, the Relay WTRU 604 may be configured to receive respective PO aligned indications from each of the one or more remote WTRUs (e.g., such as the remote WTRU 602).

At 632, the Relay WTRU 604 may start to monitor one or more PO(s) and/or the Remote WTRU 602 may schedule data delivery according to one or more agreed DRX cycle(s). For example, the Relay WTRU may be configured to monitor POs and/or data delivery of the one or more Remote WTRUs based on the available DRX cycle.

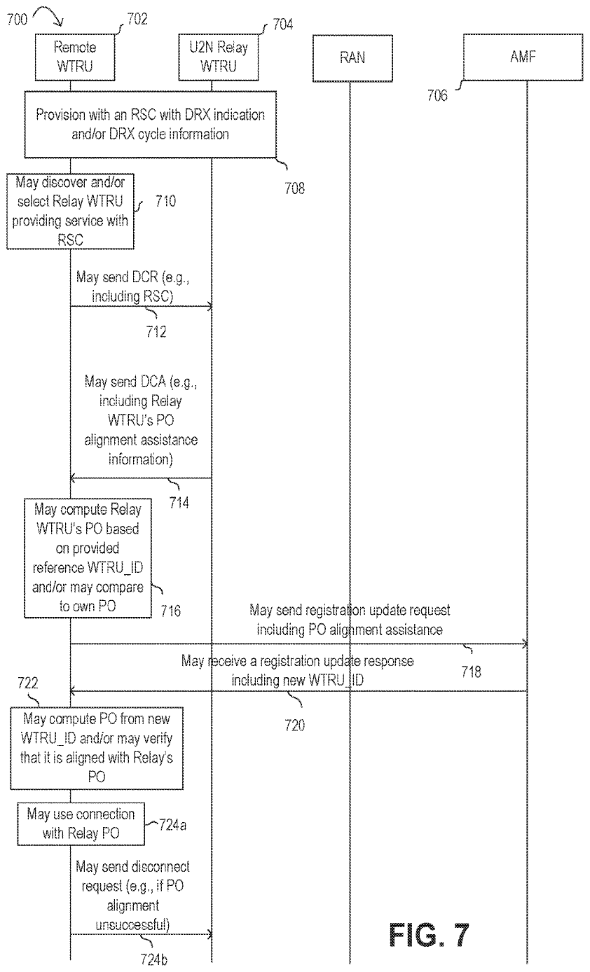

FIG. 7 is a flow chart diagram 700 illustrating an example of a Remote WTRU 702 that seeks network PO alignment based on Relay WTRU POs. For example, one or more (e.g., each) Remote WTRU 702 may request an updated WTRU_ID (e.g., based on information from the Relay WTRU 704 during connection establishment).

At 708, the Remote WTRU 702 and/or the Relay WTRU 704 may be provisioned (e.g., as described herein) with an RSC with DRX optimization indication and/or DRX cycle information.

At 710, the Remote WTRU 702 may discover and/or select (e.g., as described herein) the Relay WTRU 704 providing service with the RSC.

At 712, the Remote WTRU 702 may send a DCR to the Relay WTRU 704. The DCR may include the RSC.

At 714, the Relay WTRU 704 may send, to the Remote WTRU 702, a DCA. The DCA may include the Relay WTRU's PO alignment assistance information (e.g., Relay WTRU_ID as a reference WTRU_ID, one or more DRX parameters, etc.).

At 716, the Remote WTRU 702 may compute, as described herein, the Relay WTRU's PO based on the provided reference WTRU_ID and/or may compare to own PO.

At 718, the Remote WTRU 702 may send a registration update request message to an AMF 706. The registration update request message may include PO alignment assistance information.

At 720, the Remote WTRU 702 may receive a registration update response. For example, the Remote WTRU 702 may receive the registration update response from the AMF 706 (e.g., from the AMF 706 directly or via the Relay WTRU 704). The registration update response may include the updated (e.g., new) WTRU_ID.

At 722, the Remote WTRU 702 may compute a PO from the updated (e.g., new) WTRU_ID and/or may verify that it is aligned with the Relay's PO.

At 724a, the Remote WTRU 702 may use the connection with the Relay if PO alignment is successful. At 724b, the Remote WTRU 702 may send a disconnect request to the Relay WTRU 704 indicating PO misalignment. The disconnect request may indicate a PO misalignment reason (e.g., to select another Relay WTRU, etc.).

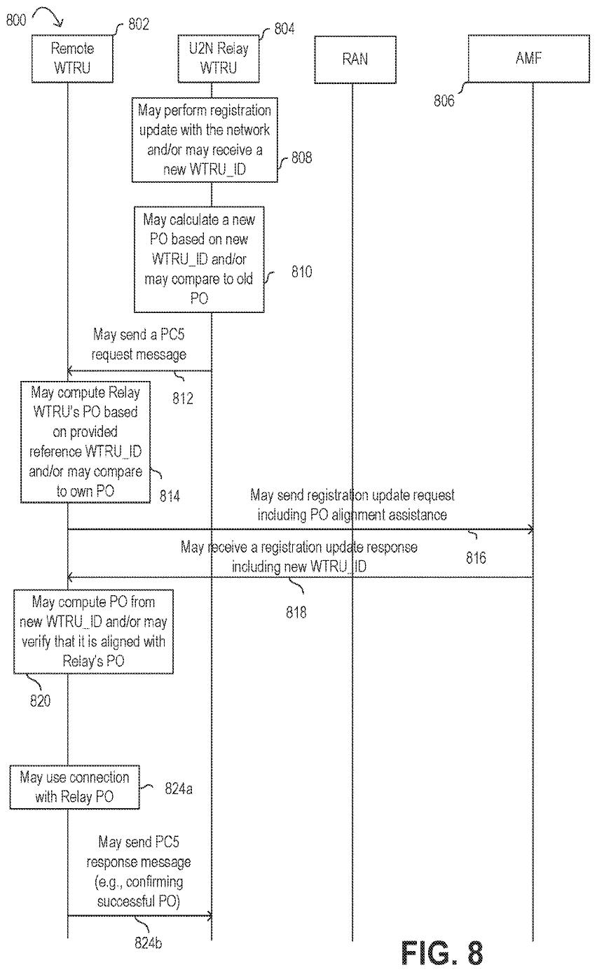

FIG. 8 is a flow chart diagram illustrating an example of a Remote WTRU that seeks network PO re-alignment 800. For example, FIG. 8 may include an example of establishing connection when a Relay WTRU 804 is triggering the PO alignment and/or update (e.g., based on one or more changes on the Relay WTRU 804 end and/or at the network).

At 808, the Relay WTRU 804 may perform registration update with the network and/or may receive a new WTRU_ID (e.g., as described herein).

At 810, the Relay WTRU 804 may calculate a new PO based on the new WTRU_ID and/or may compare to the old PO.

At 812, the Relay WTRU 804 may send a PC5 request message to one or more Remote WTRUs 802. For example, the Relay WTRU 804 may periodically send a PC5 request message to one or more Remote WTRUs 802. The PC5 request message may include one or more maintenance messages such as LMR, keep alive, etc. The PC5 request message may indicate a new WTRU_ID for the Relay WTRU 804. For example, the Relay WTRU 804 may send a PC5 message request to inform the one or more connected Remote WTRUs 802 of the updated (e.g., new) PO alignment assistance information if the updated PO is not aligned with the old PO.

At 814, the Remote WTRU 802 may compute, as described herein, the Relay WTRU's PO based on the provided reference WTRU_ID and/or may compare to own PO.

At 816, the Remote WTRU 802 may send a registration update request message to an AMF 806. The registration update request message may include PO alignment assistance information. The AMF 806 may assign a WTRU_ID (e.g., a new WTRU_ID), for example, to align the corresponding PO based on the PO alignment assistance information. The AMF 806 may store an indication in the WTRU/Relay context that WTRU/Relay WTYRU_ID allocation is subject to one or more PO alignment constraints. Additionally or alternatively, the AMF 806 may receive a registration request message from a WTRU/Relay without PO alignment assistance information (e.g., WTRU/Relay is already PO aligned). If the WTRU/Relay context has an indication that WTRU/Relay subject to PO alignment constraints and a WTRU_ID (e.g., a new WTRU_ID) is to be generated, the AMF 806 may assign a WTRU_ID (e.g., a new WTRU_ID), for example, to align the corresponding PO to the PO associated with the old WTRU_ID.

In this case, the AMF may send a registration response message that indicates the new WTRU_ID that fulfills the PO alignment requirement.

At 818, the Remote WTRU 802 may receive a registration update response. The registration update response may include the updated (e.g., new) WTRU_ID.

At 820, the Remote WTRU 802 may compute a PO from the updated (e.g., new) WTRU_ID and/or may verify that it is aligned with the Relay's PO.

At 824a, the Remote WTRU 802 may use the connection with the Relay if PO alignment is successful. At 824b, the Remote WTRU 802 may send a PC5 message to the Relay request to the Relay WTRU 804 indicating PO misalignment (e.g., if the new PO is not aligned with the old PO). The Relay WTRU

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU) comprising:
a processor configured to:
determine to change a discontinuous reception (DRX) cycle of the WTRU with respective DRX cycles of two or more remote WTRUs connected to the WTRU;
determine a specific identifier to request based on respective paging occasions (POs) of the two or more remote WTRUs and a PO of the WTRU;
send a first message to the network comprising the specific identifier and a DRX indication that indicates a request to change the DRX cycle of the WTRU with the respective DRX cycles of the two or more remote WTRUs;
receive a second message from the network indicating to use the specific identifier and an available DRX cycle; and
send a third message to the two or more remote WTRUs, the third message indicating the specific identifier, the DRX indication, and the available DRX cycle.

2. The WTRU of claim 1, wherein the processor is further configured to calculate the specific identifier based on a comparison of one or more POs of the two or more remote WTRUs with the PO of the relay WTRU.

3. The WTRU of claim 2, wherein the determination to change the DRX cycle of the WTRU is based on the comparison of the one or more POs of the two or more remote WTRUs with the PO of the relay WTRU, and wherein the processor is configured to align a DRX cycle with the at least two respective DRX cycles of two or more remote WTRUs to change the DRX cycle of the WTRU.

4. The WTRU of claim 1, wherein the processor is further configured to receive respective PO aligned indications from each of the two or more remote WTRUs.

5. The WTRU of claim 1, wherein the processor is further configured to receive a disconnect request message from a remote WTRU of the two or more remote WTRUs based on the PO alignment between the remote WTRU and the WTRU being unsuccessful.

6. The WTRU of claim 1, wherein the second message is received from an access and mobility management function (AMF).

7. The WTRU of claim 1, wherein the processor is further configured to monitor POs and data delivery of the two or more remote WTRUs based on the available DRX cycle.

8. The WTRU of claim 1, wherein the determination to align a DRX cycle of the relay WTRU with the respective DRX cycles of the two or more remote WTRUs connected to the WTRU is based on reception of a direct communication request message from one of the two or more remote WTRUs.

9. The WTRU of claim 1, wherein the specific identifier is a first specific identifier, and wherein the processor is further configured to:
perform a registration update with the network;
receive a second specific identifier in response to the registration update;
calculate an updated PO based on the second specific identifier; and
send a fourth message to the two or more remote WTRUs when the updated PO is not aligned with the initial PO, the fourth message indicating the second specific identifier.

10. The WTRU of claim 1, wherein the available DRX cycle is assigned to the WTRU and the two or more remote WTRUs based on the DRX indication.

11. A method comprising:
determining to change a discontinuous reception (DRX) cycle of a wireless transmit/receive unit (WTRU) with respective DRX cycles of two or more remote WTRUs connected to the WTRU;
determining a specific identifier to request based on respective paging occasions (POs) of the two or more remote WTRUs and a PO of the WTRU;
sending a first message to the network comprising the specific identifier and a DRX indication that indicates a request to change the DRX cycle of the WTRU with the respective DRX cycles of the two or more remote WTRUs;
receiving a second message from the network indicating to use the specific identifier and an available DRX cycle; and
sending a third message to the two or more remote WTRUs, the third message indicating the specific identifier, the DRX indication, and the available DRX cycle.

12. The method of claim 11, wherein the method further comprises calculating the specific identifier based on a comparison of one or more POs of the two or more remote WTRUs with the PO of the relay WTRU.

13. The method of claim 12, wherein determining to change the DRX cycle of the WTRU is based on the comparison of the one or more POs of the two or more remote WTRUs with the PO of the relay WTRU, and wherein the method further comprising aligning a DRX cycle with at least two respective DRX cycles of two or more remote WTRUs to change the DRX cycle of the WTRU.

14. The method of claim 11, wherein the method further comprises receiving respective PO aligned indications from each of the two or more remote WTRUs.

15. The method of claim 11, wherein the method further comprises receiving a disconnect request message from a remote WTRU of the two or more remote WTRUs based on the PO alignment between the remote WTRU and the WTRU being unsuccessful.

16. The method of claim 11, wherein the second message is received from an access and mobility management function (AMF).

17. The method of claim 11, wherein the method further comprises monitoring POs and data delivery of the two or more remote WTRUs based on the available DRX cycle.

18. The method of claim 11, wherein the determination to align a DRX cycle of the relay WTRU with the respective DRX cycles of the two or more remote WTRUs connected to the WTRU is based on reception of a direct communication request message from one of the two or more remote WTRUs.

19. The method of claim 11, wherein the specific identifier is a first specific identifier, and wherein the method further comprises:
performing a registration update with the network;
receiving a second specific identifier in response to the registration update;
calculating an updated PO based on the second specific identifier; and
sending a fourth message to the two or more remote WTRUs when the updated PO is not aligned with the initial PO, the fourth message indicating the second specific identifier.

20. The method of claim 19, wherein the available DRX cycle is assigned to the WTRU and the two or more remote WTRUs based on the DRX indication.

21. A wireless transmit/receive unit (WTRU) comprising:
a processor configured to:
send a first message to a relay WTRU, the first message comprising an identifier and discontinuous reception (DRX) cycle of the remote WTRU;
receive a second message from the relay WTRU, the second message comprising an available DRX cycle, a specific identifier, and a DRX indication that indicates the specific identifier; and
send a mobility registration update message to an access and mobility management function (AMF) based on receiving the second message from the relay WTRU; and
receive a mobility registration accept message from the AMF, the mobility registration accept message comprising information indicating aligning the DRX cycle of the remote WTRU according to the received specific identifier.
